(19) United States
(12) Patent Application Publication
(10) Pub. No.: US 2023/0162912 A1
(43) Pub. Date: May 25, 2023

(54) APPARATUS AND METHOD FOR MANUFACTURING REACTOR

(71) Applicant: TOYOTA JIDOSHA KABUSHIKI KAISHA, Toyota-shi (JP)

(72) Inventors: Shun KISHIMOTO, Miyoshi-shi (JP); Ryo YOKOZAWA, Nisshin-shi (JP)

(73) Assignee: TOYOTA JIDOSHA KABUSHIKI KAISHA, Toyota-shi (JP)

(21) Appl. No.: 18/047,362

(22) Filed: Oct. 18, 2022

(30) Foreign Application Priority Data
Nov. 22, 2021 (JP) 2021-189255

(51) Int. Cl. H01F 41/00; B29C 45/14

(52) U.S. Cl. CPC H01F 41/005; B29C 45/14065; B29C 45/14639; B29C 2045/14147

(57) ABSTRACT

An apparatus and a method for manufacturing a reactor capable of preventing a core from being cracked due to a resin pressure during molding are provided. An apparatus for manufacturing a reactor provided with a core includes a mold with a cavity for housing the core. The mold includes a core support pin brought into contact with the core and configured to support the core against a resin pressure during molding. Resin flow paths during molding includes an inner flow path passing through inside the core and an outer flow path passing through outside the core. The core support pin is disposed at a position where a width of the inner flow path is greater than a width of the outer flow path.

### CROSS REFERENCE TO RELATED APPLICATIONS

This application is based upon and claims the benefit of priority from Japanese patent application No. 2021-189255, filed on Nov. 22, 2021, the disclosure of which is incorporated herein in its entirety by reference.

### BACKGROUND

The present disclosure relates to an apparatus and a method for manufacturing a reactor.

Japanese Unexamined Patent Application Publication No. 2013-149841 discloses a method for manufacturing a reactor including a primary molding step and a secondary molding step. According to the technique described in Japanese Unexamined Patent Application Publication No. 2013-149841, a common mold can be used for both primary and secondary molding.

### SUMMARY

In the secondary molding step, when a resin preferentially enters an outer peripheral side of the core, the core cannot be supported against a resin pressure, and therefore, there is a problem that a high stress is generated in the core, and thus the core is cracked.

The present disclosure has been made in order to solve such a problem, and an object of the present disclosure is to provide an apparatus and a method for manufacturing a reactor capable of preventing a core from being cracked due to a resin pressure during molding.

In an example aspect of the present disclosure, an apparatus for manufacturing a reactor provided with a core includes: a mold including a cavity for housing the core.

The mold includes a core support pin brought into contact with the core and configured to support the core against a resin pressure during molding,

resin flow paths during molding include an inner flow path passing through inside the core and an outer flow path passing through outside the core, and

the core support pin is disposed at a position where a width of the inner flow path is greater than a width of the outer flow path.

In another example aspect of the present disclosure, a method for manufacturing a reactor provided with a core includes:

molding a molded article by using a mold including a cavity for housing the core.

The mold includes a core support pin brought into contact with the core for supporting the core against a resin pressure during molding,

resin flow paths in the molding of the molded article include an inner flow path passing through inside the core and an outer flow path passing through outside the core, and

the core support pin is disposed at a position where a width of the inner flow path is greater than a width of the outer flow path.

According to the present disclosure, it is possible to provide an apparatus and a method for manufacturing a reactor capable of preventing a core from being cracked due to a resin pressure during molding.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic top view showing an overview of a mold according to related art;

FIG. 2 is a schematic top view showing a configuration of a core;

FIG. 3 shows a dimensional relationship between an inner flow path and an outer flow path of the mold according to the related art;

FIG. 4 shows three modes of cracks of the core in the manufacturing apparatus according to the related art;

FIG. 5 is a schematic top view showing a mold of a manufacturing apparatus according to a first embodiment;

FIG. 6 shows a dimensional relationship between an inner flow path and an outer flow path of the mold according to the first embodiment;

FIG. 7 shows a preferable dimensional relationship between flow paths of the mold according to the first embodiment;

FIG. 8 shows a preferable dimensional relationship between flow paths of the mold according to the first embodiment; and

FIG. 9 shows a preferable dimensional relationship between flow paths of the mold according to the first embodiment.

### DESCRIPTION OF EMBODIMENTS

### (Study Leading to Embodiment)

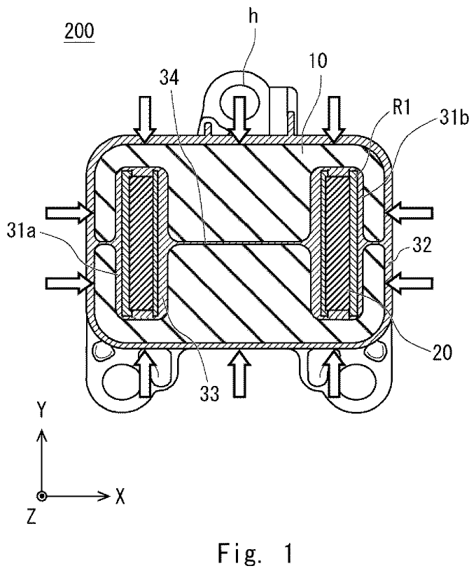

First, the contents of the study conducted by the inventor of the present application will be described. FIG. 1 is a schematic top view showing an overview of a mold 200 of a related manufacturing apparatus. The related manufacturing apparatus is an apparatus for manufacturing a reactor provided with a core. Note that the related manufacturing apparatus may further include an apparatus for opening and closing the mold 200 (not shown), a resin injection apparatus (not shown), etc. A core 10 and a coil mold 20 molded with a resin are inserted into the mold 200. A reference sign R1 indicates the resin included in the coil mold 20. Next, a resin is injected around the core 10 and the coil mold 20 to perform insert molding. A hole h, which is an insertion hole for a bolt or the like, is formed during a molding process. FIG. 1 shows an internal state of the mold 200 during insert molding.

FIG. 1 shows a three-dimensional orthogonal coordinate system of XYZ for clarity of explanation. Note that a Z direction is a vertical direction. Therefore, the Z direction is a height direction. The resin is injected, for example, in a negative direction of a Z-axis.

The mold 200 includes a cavity for housing the core 10. For example, a pair of E-shaped cores 10 are inserted into the cavity. The core 10 may be a sintered product obtained by sintering a compact.

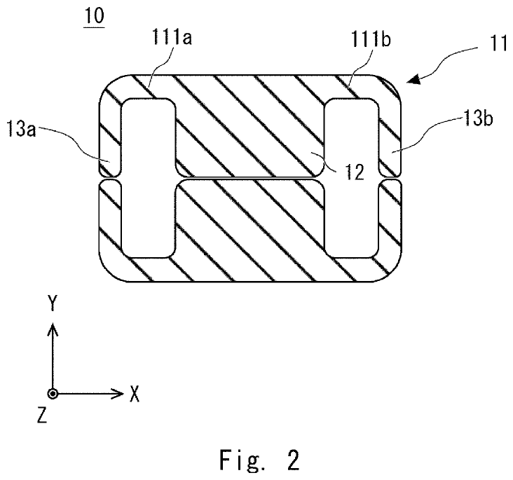

FIG. 2 is a schematic top view showing a configuration of the core 10. The core 10 includes a base core 11, a middle leg core 12, and outer leg cores 13a and 13b. Hereinafter, when the outer leg cores 13a and 13b are not distinguished from each other, they may be referred to simply as the outer leg cores 13. The middle leg core 12 and the outer leg core 13 project from the base core 11 in the same direction. In FIG. 2, an X direction indicates a direction in which the base core 11 is extended, and a Y direction indicates a direction in which the middle leg core 12 and the outer leg core 13 are extended. The coil mold 20 molded with a resin is assembled to the middle leg core 12.

The base core 11 includes a connection part 111a for connecting the middle leg core 12 to the outer leg core 13a, and a connection part 111b for connecting the middle leg core 12 to the outer leg core 13b. Hereinafter, when the connection parts 111a and 111b are not distinguished from each other, they may be simply referred to as the connection parts 111.

Widths of the outer leg cores 13a and 13b (e.g., the length thereof in the X direction) are smaller than a width of the middle leg core 12. In a reactor of a smaller size, the outer leg core 13 may become thinner, and thus the outer leg core 13 may be broken during molding.

Returning to FIG. 1, the description will be continued. The resin flow paths during molding include inner flow paths 31a and 31b passing through the inside of the core 10, an outer flow path 32 passing through the outside of the core 10, a flow path 33 passing through the inside of the coil mold 20, and a flow path 34 passing between the two cores 10. Hereinafter, when the inner flow paths 31a and 31b are not distinguished from each other, they may be referred to simply as the inner flow paths 31. When the inner flow paths 31, the outer flow path 32, the flow path 33, and the flow path 34 are not distinguished from each other, they may be simply referred to as the flow paths 30. In the related mold 200, a resin is preferentially injected into the outer flow path 32. Therefore, there is a problem that the core 10 is pressurized from the outside to the inside as indicated by the arrow, and the core 10 is broken.

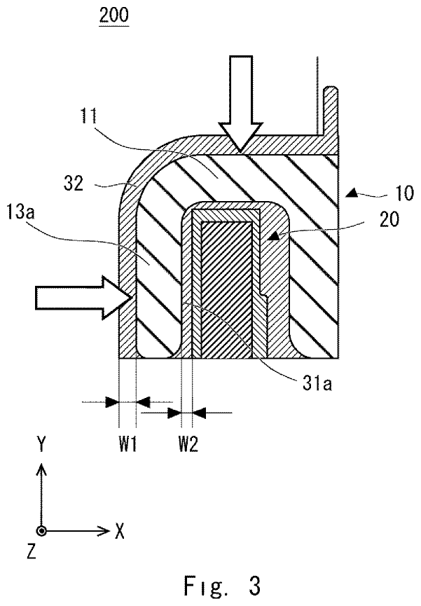

FIG. 3 is a schematic view showing a dimensional relationship between the outer flow path 32 and the inner flow path 31a in the mold 200. In the related mold 200, a width W1 of the outer flow path 32 in the X-direction is greater than a width W2 of the inner flow path 31a in the X-direction. In such a case, the outer leg core 13a of the core 10 is pressurized in the direction indicated by the rightward arrow. Similarly, a width of the outer flow path 32 in the Y direction is greater than a width of the inner flow path 31a in the Y direction. Accordingly, the base core 11 of the core 10 is pressurized in the direction indicated by the downward arrow. Since the mold 200 does not include a mechanism for supporting the core 10 against the resin pressure, there is a possibility that a high stress may be generated in the core 10, and thus the core may be cracked.

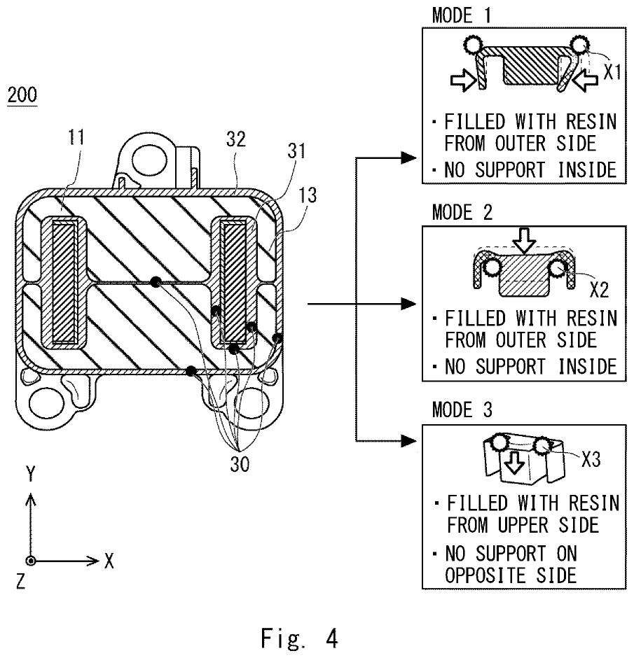

In order to prevent the core 10 from being cracked, the inventor studied the relationship between the size of each flow path 30 and the cracking modes of the core 10. FIG. 4 is a schematic view showing three cracking modes of the core 10. A mode 1 occurs when the outer flow path 32 is filled with a resin first. In the mode 1, the outer leg core 13 is pressurized in the X direction as indicated by the arrow, and a high stress is generated in a part X1. A possible cause of the mode 1 may be because there is no support mechanism inside the outer leg core 13.

A mode 2 occurs also when the outer flow path 32 is filled with a resin first. In the mode 2, the base core 11 is pressurized in the Y direction as indicated by the arrow, and a high stress is generated in a part X2. A possible cause of the mode 2 may be because there is no support mechanism inside the base core 11.

A mode 3 occurs when the core 10 is filled with a resin first from an upper side of the core 10. In the mode 3, the core 10 is pressurized downward as indicated by the arrow, and a high stress is generated in a part X3. A possible cause of the mode 3 may be because there is no support mechanism on a lower side of the core 10 (e.g., on the negative direction side of the Z-axis).

The inventor of the present application arrived at the present disclosure according to the embodiment based on the above study. Hereinafter, the present disclosure will be described through an embodiment of the disclosure, but the disclosure according to the claims is not limited to the following embodiment. Further, not all of the configurations described in the embodiment are essential as means for solving the problem.

### First Embodiment

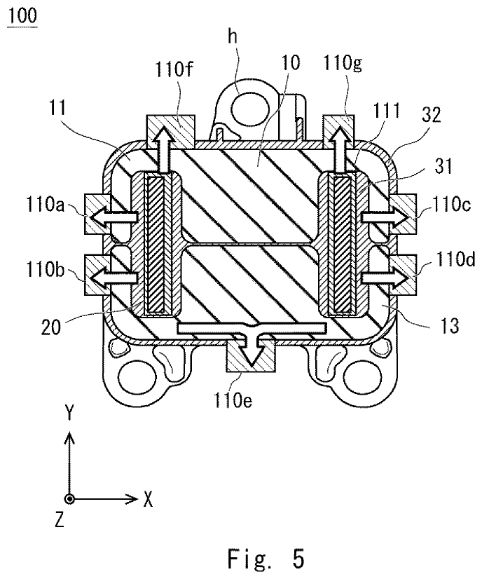

A manufacturing apparatus according to a first embodiment will be described below with reference to the drawings. FIG. 5 is a schematic top view showing an overview of a mold 100 of the manufacturing apparatus according to the first embodiment. In the following description, differences of the mold 100 of the manufacturing apparatus according to the first embodiment from the mold 200 of the related manufacturing apparatus will be mainly described.

The mold 100 includes core support pins 110a, 110b, 110c, 110d, 110e, 110f, and 110g. Hereinafter, when the core support pins 110a, 110b, 110c, 110d, 110e, 110f, and 110g are not distinguished from each other, they may be referred to simply as the core support pins 110. Since a resin does not flow into parts of the mold 100 that are in contact with the core support pins 110, windows corresponding to the core support pins 110 are formed in a molded article.

The core support pins 110 are in contact with the core 10 and support the core 10 against the resin pressure during molding. The core support pins 110a, 110b, 110c, and 110d support the outer leg core 13 against the resin pressure indicated by the arrows in the ±X direction during molding. The core support pins 110e, 110f, and 110g support the base core 11 against the resin pressure indicated by the arrows in the ±Y direction during molding. The downward arrow indicates that the resin pressure is received from both of the two inner flow paths 31. The core support pins 110e and 110f support the connection part 111 included in the base core 11.

The core support pins 110a, 110b, 110c, 110d, 110e, and 110f are located at positions where the widths of the inner flow paths 31 are greater than that of the outer flow path 32. Some of the core support pins 110 (e.g., the core support pin 110e) may be disposed at other positions.

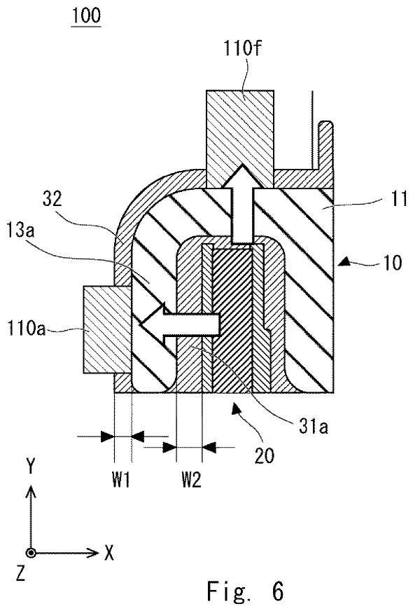

FIG. 6 is a schematic view showing a dimensional relationship between the outer flow path 32 and the inner flow path 31a in the mold 100. The outer flow path 32 includes a flow path outside the outer leg core 13a. The inner flow path 31a includes a flow path in a gap between the coil mold 20 and the outer leg core 13a.

In the mold 100, the width W2 of the inner flow path 31a in the X direction is greater than the width W1 of the outer flow path 32 in the X direction. In other words, a width of the above-mentioned gap is greater than the width of the flow path outside the outer leg core 13a. In such a case, the outer leg core 13a of the core 10 is pressurized in the direction indicated by the leftward arrow. The core support pin 110a supports the outer leg core 13a against the pressure in the direction of the leftward arrow to prevent deformation of the outer leg core 13a.

Similarly, the width of the inner flow path 31a in the Y direction is greater than the width of the outer flow path 32 in the Y direction. Accordingly, the base core 11 of the core 10 is pressurized in the direction indicated by the upward arrow. The core support pin 110f supports the base core 11 against the pressure in the direction of the upward arrow to prevent the deformation of the base core 11.

The mold 100 is designed in such a way that the widths of the inner flow paths 31 become greater than the width of the outer flow path 32, so that the core 10 can be prevented from being deformed inward and broken. The core 10 is supported from the outside by the core support pins 110, and thus the mold 100 can prevent the core 10 from being deformed outward and broken. Therefore, the manufacturing apparatus according to the first embodiment can prevent the core 10 from being broken by the resin pressure during molding.

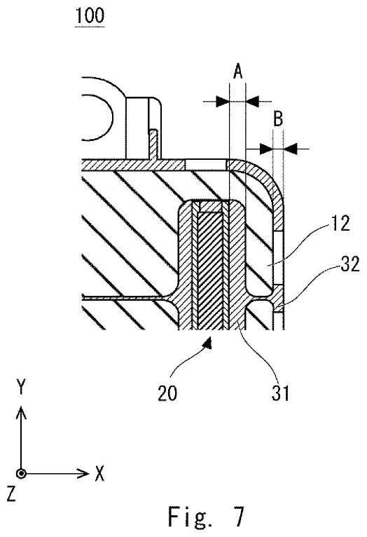

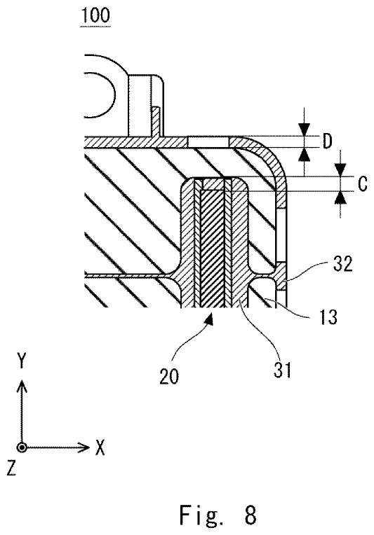

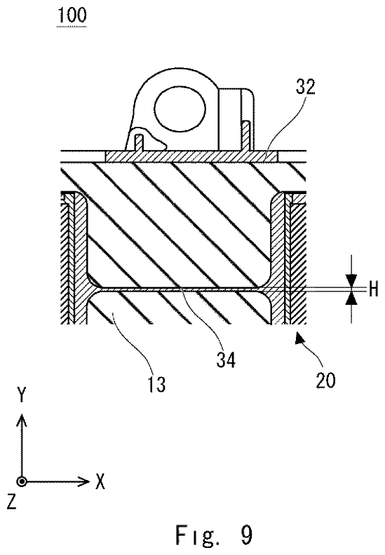

Next, a preferred dimensional relationship of the flow paths 30 will be described with reference to FIGS. 7 to 9. FIGS. 7 to 9 shows preferable dimensional relationships between the flow paths 30. In FIGS. 7 to 9, the core support pins 110 are not shown. A reference sign A in FIG. 7 indicates the width of the inner flow path 31 in the X direction. A reference sign B in FIG. 7 indicates a width B in the X direction of the outer flow path 32. A reference sign C in FIG. 8 indicates the width of the inner flow path 31 in the Y direction. A reference sign D in FIG. 8 indicates the width of the outer flow path 32 in the Y direction. A reference sign H in FIG. 9 indicates the width of the above-mentioned flow path 34. The inventor has found that cracking of the above-described modes 1 to 3 can be prevented by satisfying the following first to third dimensional relationships.

Referring to FIG. 7, the first dimensional relationship is that A>B and 0.5≤B≤2 (in mm) hold. In relation to the above-described mode 1, the width of the inner flow path 31 in the X direction is set to be greater than the width of the outer flow path 32 in the X direction. The width of the outer flow path 32 in the X direction can be selected within a range from 0.5 mm to 2 mm.

Referring to FIG. 8, the second dimensional relationship is that C>D and 0.5≤D≤2 (in mm) hold. In relation to the above-described mode 2, the width of the inner flow path 31 in the Y direction must be set to be larger than the width of the outer flow path 32 in the Y direction. Furthermore, in relation to the above-described mode 3, it is necessary to set the width of the outer flow path 32 in the Y direction appropriately.

Referring to FIG. 9, the third dimensional relationship is that 0.4≤H≤2 (in mm) holds, and at least one of the outer leg cores 13a or the outer leg cores 13b are in contact with each other. In relation to the above-described modes 2 and 3, the width of the flow path 34 must be selected within a range from 0.4 mm to 2 mm.

In the manufacturing apparatus according to the first embodiment, since the size of the inner flow path is larger than that of the outer flow path, a resin is first injected into the inside of the core 10, and the core subjected to the resin pressure is supported by the pins provided in the mold. Therefore, the manufacturing apparatus according to the first embodiment can prevent the core 10 from being broken by reducing the deformation of the core and reducing the stress inside the core.

Note that the present disclosure is not limited to the above-described embodiment, and may be suitably modified without departing from the spirit.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An apparatus for manufacturing a reactor including a core, the apparatus comprising:
a mold including a cavity for housing the core, wherein
the mold includes a core support pin brought into contact with the core and configured to support the core against a resin pressure during molding,
resin flow paths during molding include an inner flow path passing through inside the core and an outer flow path passing through outside the core, and
the core support pin is disposed at a position where a width of the inner flow path is greater than a width of the outer flow path.

2. The apparatus according to claim 1, wherein
the apparatus is an apparatus for manufacturing a reactor including a pair of E-shaped cores, and
each of the E-shaped cores includes an outer leg core and a middle leg core projecting in the same direction from a base core, and
a width of the outer leg core is smaller than a width of the middle leg core.

3. The apparatus according to claim 2, wherein
the core support pin supports the outer leg core.

4. The apparatus according to claim 3, wherein
a coil mold molded with a resin is assembled to the middle leg core,
the inner flow path includes a flow path in a gap between the coil mold and the outer leg core,
the outer flow path includes a flow path outside the outer leg core, and
a width of the gap is greater than a width of the flow path outside the outer leg core.

5. The apparatus according to claim 2, wherein
the base core includes a connection part connecting the middle leg core to the outer leg core, and
the core support pin supports the connection part.

6. A method for manufacturing a reactor including a core, the method comprising:
molding a molded article by using a mold including a cavity for housing the core, wherein
the mold includes a core support pin brought into contact with the core for supporting the core against a resin pressure during molding,
resin flow paths in the molding of the molded article include an inner flow path passing through inside the core and an outer flow path passing through outside the core, and
the core support pin is disposed at a position where a width of the inner flow path is greater than a width of the outer flow path.
